(19) United States
(12) Patent Application Publication
(10) Pub. No.: US 2026/0322580 A1
(43) Pub. Date: Oct. 15, 2026

(54) Codeword Synchronization Method for Sunspec System Receiver

(71) Applicant: Leaguer (Shenzhen) Microelectronics Corp., Shenzhen (CN)

(72) Inventors: Guangxing Jiang, Shenzhen (CN); Liheng Chen, Shenzhen (CN); Kun Liu, Shenzhen (CN)

(21) Appl. No.: 19/683,696

(22) Filed: May 20, 2026

Related U.S. Application Data
(63) Continuation of application No. PCT/CN2024/111408, filed on Aug. 12, 2024.

(30) Foreign Application Priority Data
Mar. 29, 2024 (CN) 202410375974.1

(51) Int. Cl. H04L 7/00; H04L 7/033; H04L 27/12

(52) U.S. Cl. CPC H04L 7/0087; H04L 7/033; H04L 27/12

(57) ABSTRACT

The present invention discloses a codeword synchronization method for a Sunspec system receiver. The method includes: receiving a time-domain signal, locking and tracking the signal via a PLL to acquire frequency discrimination information; performing integrated data decision based on carrier frequencies Fm and Fs; generating a local template composed of +1 and −1; calculating a first cross-correlation function value; determining a codeword transmission interval; computing a second cross-correlation function value with three codewords; and judging the synchronization position. This method features simple calculation and low complexity, with accurate, robust synchronization and strong anti-interference performance, and is insensitive to crystal oscillator deviation.

### CROSS REFERENCE TO RELATED APPLICATIONS

This application is a continuation application of PCT/CN2024/111408 filed on 2024 Aug. 12, which claims priority to CN patent application No. CN202410375974.1 filed on 2024 Mar. 29. The contents of the above-mentioned applications are all hereby incorporated by reference.

### TECHNICAL FIELD

The present invention relates to the technical field of photovoltaic power generation, and in particular, to a codeword synchronization method for a Sunspec system receiver.

### BACKGROUND

Power Line Communication (PLC) is a communication technology that uses power lines as a medium to realize data transmission. A digital signal is modulated and transmitted in the form of a carrier wave, then modulated by a PLC transceiver and loaded onto the power line for transmission, while reception is a reverse process.

A photovoltaic power generation system consists of photovoltaic strings formed by connecting multiple photovoltaic modules in series, and the photovoltaic strings are then connected to an inverter to convert direct current into alternating current for grid-connected power generation. Considering that series-connected photovoltaic modules generate a direct current high voltage of 600V to 1000V, which poses risks of personal injury and fire accidents, Sunspec standard-compliant photovoltaic rapid shutdown devices can achieve module-level rapid shutdown in emergency situations.

The Sunspec rapid shutdown protocol is a PLC protocol specifically formulated for the rapid shutdown function of photovoltaic systems. The Sunspec protocol stipulates that the modulation method adopts Binary Frequency Shift Keying (B-FSK). The principle of B-FSK modulation is shown in FIG. 2. The two carrier frequencies specified by Sunspec are Fm=131.25 kHz and Fs=143.75 kHz, which fall within the CENELEC B/C/D frequency bands for narrowband communication. In addition, the two types of valid transmission instructions specified by Sunspec include a shutdown instruction and a normal operation instruction, and the complete transmission cycle of one instruction is 1070.08 ms.

However, the power line channel transmission environment is extremely harsh, featuring various complex noises, strong narrowband interference, and severe frequency selectivity, all of which pose great obstacles to the reliable transmission of signals. Effective technologies are required to ensure the high efficiency and robustness of signal transmission and guarantee the safe and reliable operation of photovoltaic systems.

Codeword synchronization is a critical issue in Sunspec systems. The performance of codeword synchronization directly determines whether Sunspec systems can be widely applied in the field of photovoltaic communication.

Therefore, designing a high-performance codeword synchronization method to ensure accurate synchronization between the transmitter and receiver of a Sunspec system and lay a solid foundation for the subsequent demodulation of Sunspec system signals is a problem to be solved for Sunspec systems based on spread-spectrum B-FSK modulation.

### SUMMARY OF THE INVENTION

To solve the codeword synchronization problem of Sunspec systems, the present invention provides a codeword synchronization method for a Sunspec system receiver. This method can adapt to the complex environmental requirements of direct-current photovoltaic communication systems, realize accurate codeword symbol synchronization between the transmitter and receiver of a Sunspec system, lay a foundation for the subsequent demodulation of Sunspec data, and enable the receiver to perform correct decoding.

To achieve the above objective, the present invention adopts the following technical solution: A codeword synchronization method for a Sunspec system receiver, comprising the following steps:
S1: Receive a time-domain signal, perform locking and tracking of the time-domain signal via a Phase-Locked Loop (PLL), and acquire frequency discrimination information of the received signal;
S2: Perform integrated data decision on the frequency discrimination information of the received signal based on the frequency points corresponding to the Sunspec modulation carrier signals Fm and Fs, so as to obtain and output an integrated data decision result;
S3: Determine a local template according to the codeword W0, the modulation bit transmission time and the integrated data decision duration, wherein the local template consists of +1 and −1;
S4: Calculate the correlation between the local template and the integrated data decision result to obtain a first cross-correlation function value;
S5: Determine the codeword transmission interval between codewords according to the relationship between the codeword transmission cycle and the integration duration;
S6: Based on the codeword transmission interval, jointly calculate the correlation between three codewords and the absolute value of the first cross-correlation function value to obtain a second cross-correlation function value;
S7: Judge the codeword synchronization position according to the second cross-correlation function value.

In some embodiments, the step S1 further comprises:

The Phase-Locked Loop (PLL) comprises a phase discriminator, a high-performance loop filter, a phase accumulator and a low-pass filter. The PLL is used for FSK locking and tracking under a low signal-to-noise ratio, and for frequency discrimination output.

In some embodiments, step S2 includes:

Select an appropriate receiver sampling rate fs and integration duration

$$Δ T = \frac{N}{{f}_{s}}$$

according to the modulation bit transmission time and the FSK carrier modulation frequencies Fm and Fs specified by the Sunspec system, where N is the number of integration points, and

$$\{ \begin{matrix}{f}_{s} > 4 \cdot {F}_{S} \\ Ratio = \frac{{T}_{S} \cdot {f}_{s}}{N}\end{matrix}$$

where Ratio is a positive integer greater than or equal to 2.

Herein, the receiver sampling rate is fs, the integration duration is

$$Δ T = \frac{N}{{f}_{s}} ,$$

N is the number of integration points, Ts=5.12 ms, Fm=131.25 kHz, and Fs=143.75 kHz.

Perform integrated data decision on the received signal frequency discrimination information output PLL_out, where the integration calculation is as follows:

$${Inte\_R}_{m} = {\sum }^{N - 1} Pll\_out ( n )$$

The rule expression for the integrated data decision result is:

$$DD ( m ) = \{ \begin{matrix}1 , & {Inte\_R}_{m} > PThr \\ - 1 , & {Inte\_R}_{m} < - PThr \\ 0 , & others\end{matrix}$$

where PThr is an energy threshold greater than 1, n denotes the n-th sampling instant, m denotes the m-th integration period, and Inte_Rm is the accumulated value of N signal frequency discrimination data points.

In some embodiments, step S3 includes:

Calculate the time-domain expansion count according to the modulation bit transmission time of the Sunspec system and the integrated data decision duration. The expression for the time-domain expansion count is:

$$NC = \frac{{T}_{S}}{Δ T} = \frac{{T}_{S} \cdot {f}_{s}}{N}$$

where Ts denotes the modulation bit transmission time, ΔT denotes the integration duration, fs denotes the sampling rate, and NC denotes the time-domain expansion count.

Obtain the local template according to the codeword W0[11]={+1, +1, +1, −1, −1, −1, +1, −1, −1, +1, −1} of the Sunspec system. The expression for the local template is:

$$W\_moban [ NC * 11 ] = \text{} \{ {\overbrace{W {0}_{0} , W {0}_{0} , … , W {0}_{0} , W {0}_{0}}}^{NC} , \\ {\overbrace{W {0}_{1} , W {0}_{1} , … , W {0}_{1} , W {0}_{1}}}^{NC} , …… , \\ {\overbrace{W {0}_{9} , W {0}_{9} , … , W {0}_{9} , W {0}_{9}}}^{NC} , {\overbrace{W {0}_{10} , W {0}_{10} , … , W {0}_{10} , W {0}_{10}}}^{NC} \}$$

where NC×11 represents the correlation data length.

In some embodiments, in step S4, the expression for the first cross-correlation function is:

$${C}_{1} ( d ) = {\sum }^{NC * 11 - 1} DD ( d + m ) \cdot W\_moban ( m ) ;$$

where NC×11 represents the correlation data length, and DD(d+m) denotes the integrated data decision result of the (d+m)-th period.

In some embodiments, in step S5, the expression for the codeword transmission interval is:

$$CW\_D = \frac{{T}_{S}}{Δ T} * 11 = \frac{{T}_{S} \cdot {f}_{s}}{N} * 11 = \frac{11 \cdot {T}_{S} \cdot {f}_{s}}{N}$$

where CW_D denotes the codeword transmission interval, Ts denotes the modulation bit transmission time, ΔT denotes the integration duration, fs denotes the sampling rate, and N denotes the number of integration points.

In some embodiments, in step S6, the expression for the second cross-correlation function value is:

$${C}_{2} ( d ) = {\sum }_{k = 0}^{2} \vert [ {C}_{1} ( d + k \cdot CW\_D ) ] \vert where {C}_{2} ( d )$$

denotes the second cross-correlation function value.

In some embodiments, step S7 includes the following steps:
S71. Set a codeword synchronization threshold and a correlation peak window;
S72. Search for the maximum peak value within the correlation peak window according to the magnitude of the second cross-correlation function value relative to the codeword synchronization threshold, and determine the codeword synchronization position.

### Beneficial Effects

The present invention performs frequency discrimination on FSK modulated data and realizes integral accumulation through high-performance locking and tracking of the PLL, further filters out noise, and achieves initial data decision. It adopts an embodiment combining primary correlation and secondary correlation algorithms formed by expansion of spread-spectrum codewords, so as to adapt to the complex power line noise and interference channel environment of the Sunspec system, realize accurate codeword synchronization of the Sunspec system, further accurately estimate the start position of codeword symbols, and ensure correct decoding at the receiver. This effectively assists reliable reception of Sunspec system signal, and also has the advantages of simple implementation, low computational complexity, excellent performance, and high reliability.

Other beneficial effects in the embodiments of the present invention will be further described hereinafter.

### BRIEF DESCRIPTION OF THE DRAWINGS

FIG. 1 is a flow chart of the codeword synchronization method in an embodiment of the present invention;

FIG. 2 is a schematic diagram of B-FSK modulation of a Sunspec system in the prior art;

FIG. 3 is a schematic diagram of a Sunspec PLC transmission signal frame structure in an embodiment of the present invention;

FIG. 4 is a performance schematic diagram of the secondary correlation function and decision noise floor under a harsh channel with 0 dB Gaussian white noise in an embodiment of the present invention;

FIG. 5 is a performance schematic diagram of the secondary correlation function and decision noise floor under an extremely harsh channel with −25 dB Gaussian white noise in an embodiment of the present invention.

### DETAILED DESCRIPTION OF THE EMBODIMENTS

The present invention will be further described below with reference to the accompanying drawings and preferred embodiments. It should be noted that the embodiments in the present application and features in the embodiments may be combined with each other without conflict.

It should be noted that directional terms such as left, right, up, down, top, bottom in the present embodiment are merely relative concepts or refer to the normal operating state of the product, and shall not be deemed restrictive.

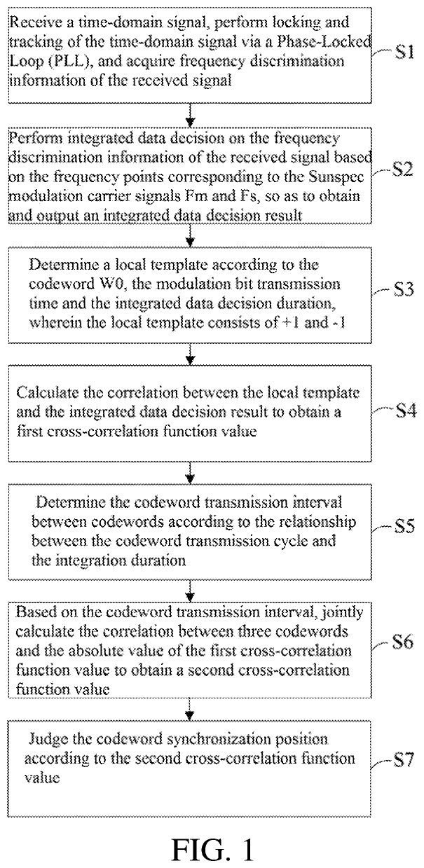

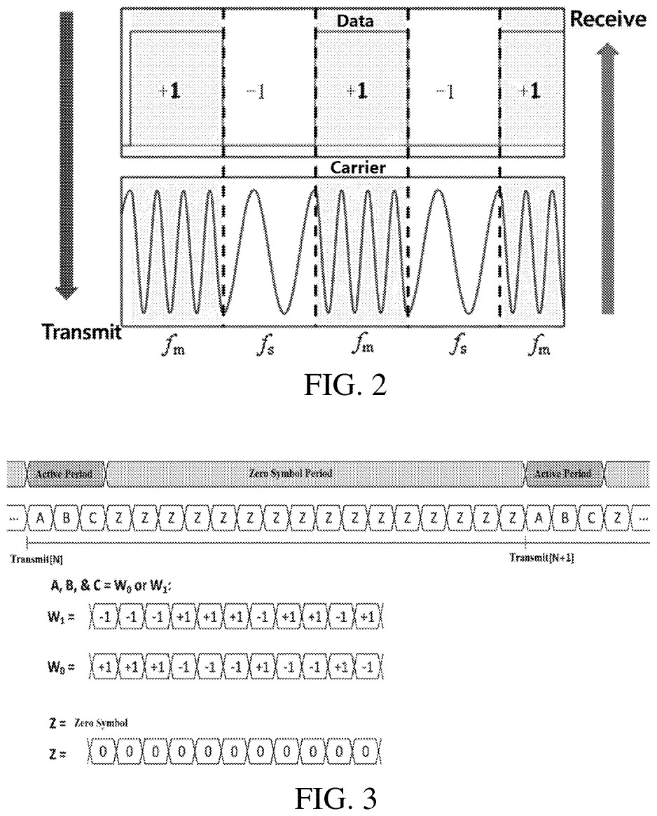

As shown in FIG. 1, a specific implementation of an embodiment of the present invention provides a codeword synchronization method for a Sunspec system receiver, which realizes codeword symbol synchronization.

In a specific embodiment of the present invention, the adopted system parameters are defined as shown in the table below:

TABLE 1
Sunspec Communication System Parameters

| Index | Value |
|---|---|
| B-FSK carrier | Fm = 131.25 kHz, Fs = 143.75 kHz |
| frequency | |
| Codeword W0 | Logic 0 codeword W0[11] = {+1, +1, +1, −1, −1, −1, +1, −1, −1, +1, −1} |
| Codeword W1 | Logic 1 codeword W1[11] = {−1, −1, −1, +1, +1, +1, −1, +1, +1, −1, +1} |
| Zero-energy | Zero−energy codeword Z[11] = {0, 0, 0, 0, 0, 0, 0, 0, 0, 0, 0} |
| codeword Z | |
| Cyclic | {A, B, C, Z, Z, Z, Z, Z, Z, Z, Z, Z, Z, Z, Z, Z, Z, Z, Z}, where A, B, C are |
| transmission format | codeword W0 or codeword W1, and Z is the zero-energy codeword |
| Modulation bit | Approx. 5.12 ms, fluctuation affected by crystal oscillator deviation |
| transmission time | |
| (Bit Period) | |
| ABC transmission | Approx. 168.96 ms, fluctuation affected by crystal oscillator |
| duration | deviation |
| Static duration | Approx. 901.12 ms, fluctuation affected by crystal oscillator |
| | deviation |
| Crystal oscillator | ±100 ppm |
| deviation | |

Accordingly, the Sunspec rapid shutdown PLC protocol transmits signal instructions periodically, whose frame structure is shown in FIG. 3 below.

The present embodiment specifically includes the following steps:
S1 Perform high-performance locking and tracking on the received time-domain signal by a Phase-Locked Loop (PLL), and acquire frequency discrimination information of the received signal.

The PLL is composed of a phase detector, a high-performance loop filter, a phase accumulator, and a low-pass filter with favorable filtering characteristics. It realizes FSK locking and tracking under low signal-to-noise ratio and outputs high-performance frequency discrimination.

S2 Perform integrated data decision on the Sunspec received signal frequency discrimination information based on the frequency points corresponding to the Sunspec modulation carriers Fm and Fs, to obtain and output an integrated data decision result.

Accordingly, a proper receiver sampling rate fs (kHz) and integration duration

$$Δ T = \frac{N}{{f}_{s}}$$

(where N is the number of integration points) are selected based on the modulation bit transmission time (Bit Period) and the Sunspec-specified FSK carrier modulation frequencies Fm=131.25 kHz and Fs=143.75 kHz, where:

$$\{ \begin{matrix}{f}_{s} > 4 \cdot {F}_{S} \\ Ratio = \frac{{T}_{S} \cdot {f}_{s}}{N}\end{matrix}$$

where Ratio is a positive integer ≥2.

To improve the system's anti-noise performance, integrated data decision is performed on the Sunspec received signal frequency discrimination output PLL_out, with the integration calculation as follows:

$${Inte\_R}_{m} = {{\sum }_{n = 0}}^{N - 1} Pll\_out ( n )$$

In the present embodiment, the receiver sampling rate fs is set to 1000 kHz, the number of integration points N is set to 640, corresponding to an integration duration ΔT=0.64 ms.

The rule expression for the integrated data decision result is:

$$DD ( m ) = \{ \begin{matrix}1 , & {Inte\_R}_{m} > PThr \\ - 1 , & {Inte\_R}_{m} < - PThr \\ 0 , & others\end{matrix}$$

where PThr is an energy threshold greater than 1, n denotes the n-th sampling instant, m denotes the m-th integration period, and Inte_Rm is the accumulated value of N signal frequency discrimination data points. In the present embodiment, the PLL output is normalized with a designed value of 0.3, and the above integrated data decision rule is adopted.

S3 Determine the local template according to codeword W0, the modulation bit transmission time (Bit Period) and the integrated data decision duration, wherein the local template is composed of +1 and −1.

In this embodiment, the time-domain expansion count NC is calculated according to the modulation bit transmission time (Bit Period, Ts) and the integration duration ΔT of the Sunspec system:

$$NC = \frac{{T}_{S}}{Δ T} = \frac{{T}_{S} \cdot {f}_{s}}{N} = 8$$

Furthermore, the local template W_moban[NC×11] is obtained according to the Sunspec system codeword W0[11]={+1, +1, +1, −1, −1, −1, +1, −1, −1, +1, −1}:

$$W\_moban [ 88 ] = \text{} \{ {\overbrace{W {0}_{0} , W {0}_{0} , … , W {0}_{0} , W {0}_{0}}}^{8} , \\ {\overbrace{W {0}_{1} , W {0}_{1} , … , W {0}_{1} , W {0}_{1}}}^{8} , \\ …… , {\overbrace{W {0}_{9} , W {0}_{9} , … , W {0}_{9} , W {0}_{9}}}^{8} , {\overbrace{W {0}_{10} , W {0}_{10} , … , W {0}_{10} , W {0}_{10}}}^{8} \}$$

At this time, the maximum codeword position deviation is Ts/NC/2=Ts/16=0.32 ms, and the corresponding codeword positioning accuracy is fully sufficient, equivalent to 1/16 of one bit transmission time (Bit Period).

S4 Calculate the correlation between the local template and the integrated data decision result to obtain a first cross-correlation function value.

Furthermore, the correlation between the local template and the integrated data decision result DD(d+m) is calculated to obtain the first cross-correlation function C₁(d):

$${C}_{1} ( d ) = {\sum }_{m = 0}^{NC * 11 - 1} DD ( d + m ) \cdot W\_moban ( m )$$

where NC×11=88 represents the correlation data length, and DD(d+m) denotes the integrated data decision result of the (d+m)-th period.

S5 Determine the codeword transmission interval between codewords according to the relationship between the codeword transmission cycle and the integration duration.

Meanwhile, the transmission interval CW_D between codewords is determined according to the relationship between the codeword transmission cycle and the integration duration:

$$CW\_D = \frac{{T}_{S}}{Δ T} * 11 = \frac{{T}_{S} \cdot {f}_{s}}{N} * 11 = \frac{11 \cdot {T}_{S} \cdot {f}_{s}}{N} = 88$$

S6 Based on the codeword transmission interval, jointly calculate the correlation between three codewords and the absolute value of the first cross-correlation function value to obtain a second cross-correlation function value.

Based on the codeword transmission interval, the correlation between three codewords and the absolute value of the first cross-correlation function value is jointly calculated to obtain the second cross-correlation function value C₂(d):

$${C}_{2} ( d ) = {\sum }_{k = 0}^{2} \vert [ {C}_{1} ( d + k \cdot 88 ) ] \vert$$

S7 Determine the codeword synchronization position according to the second cross-correlation function value.

Set a codeword synchronization threshold and a correlation peak window.

Search for the maximum peak value within the correlation peak window according to the magnitude of the second cross-correlation function value relative to the codeword synchronization threshold, and determine the accurate codeword synchronization position.

In this embodiment, a proper correlation decision threshold (codeword synchronization threshold) Thr is set. This threshold is generally designed according to the noise correlation peak. In this embodiment, Thr=140 is adopted, which is 0.53 times the ideal peak value of 88×3.

Meanwhile, a proper correlation peak window is designed.

The correlation peak window is determined according to the actual codeword transmission interval to ensure it is longer than one codeword transmission interval. Therefore, the correlation peak window is designed to be 100, exceeding one correlation length.

The second cross-correlation function is used to judge the occurrence position of the correlation peak, namely:

J(d)=C₂(d)>Thr

Judge whether the value of the correlation decision function J(d) is greater than Thr. If yes, open the correlation peak window, and search for the position where the correlation decision function J(d) reaches the maximum value within the correlation peak window. This maximum position is the codeword synchronization position.

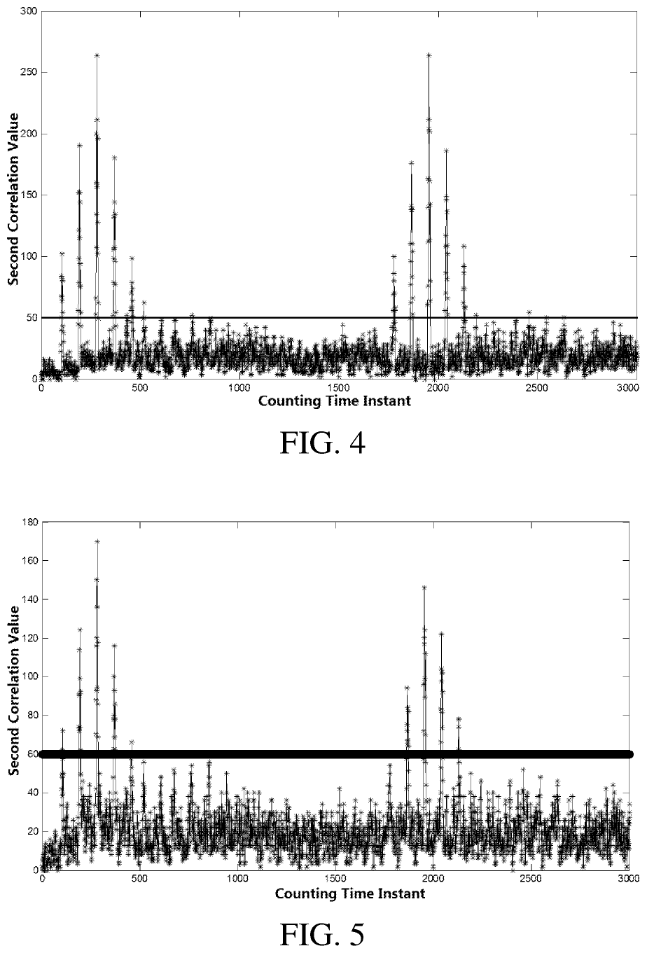

The above are the complete steps of the codeword synchronization method for a Sunspec system receiver. To further demonstrate the performance of the above method, this embodiment further models a complex power line noise channel for simulation. Through modeling, the performance schematic diagram of the secondary correlation function and the decision noise floor of the codeword synchronization algorithm in this embodiment under a harsh channel with 0 dB Gaussian white noise is first simulated. It can be seen from FIG. 4 that the secondary correlation value in FIG. 4 is the second cross-correlation function value of the embodiment of the present invention, and the counting time is the integration period in the embodiment of the present invention. The noise floor is approximately 50, while the decision threshold in this embodiment is 140, and the maximum value of the secondary correlation is approximately 264, showing very high distinguishability and performance margin.

Furthermore, the performance schematic diagram of the secondary correlation function and the decision noise floor of the codeword synchronization algorithm in this embodiment under an extremely harsh channel with −25 dB Gaussian white noise is simulated. It can be seen from FIG. 5 that the secondary correlation value in FIG. 5 is the second cross-correlation function value of the embodiment of the present invention, and the counting time is the integration period in the embodiment of the present invention. The noise floor is approximately 60, while the decision threshold in this embodiment is 140, and the maximum value of the secondary correlation is approximately between 150 and 170, showing certain distinguishability and being close to the performance limit. This fully reflects the superiority of the method in this embodiment, which can well meet the application requirements of harsh photovoltaic communication environments.

The above content is a further detailed description of the present invention in conjunction with specific embodiments, and it shall not be deemed that the specific implementation of the present invention is limited to these descriptions. For those skilled in the technical field to which the present invention belongs, several equivalent substitutions or obvious modifications can be made without departing from the concept of the present invention, and those with the same performance or purpose shall be deemed to fall within the protection scope of the present invention.

What is claimed is:

1. A codeword synchronization method for a Sunspec system receiver, comprising the steps of:
S1: receiving a time-domain signal, performing locking and tracking of the time-domain signal by a phase-locked loop (PLL), and obtaining frequency discrimination information of the received signal;
S2: performing integrated data decision on the frequency discrimination information of the received signal based on frequency points corresponding to Sunspec modulation carrier signals Fm and Fs, and obtaining and outputting an integrated data decision result;
S3: determining a local template according to codeword W0, modulation bit transmission time and integrated data decision duration, wherein the local template consists of +1 and −1;
S4: obtaining a correlation between the local template and the integrated data decision result to acquire a first cross-correlation function value;
S5: determining a codeword transmission interval between codewords according to a relationship between a codeword transmission cycle and the integration duration;
S6: jointly calculating a correlation between three codewords and an absolute value of the first cross-correlation function value based on the codeword transmission interval to acquire a second cross-correlation function value;
S7: judging a codeword synchronization position according to the second cross-correlation function value.

2. The codeword synchronization method for a Sunspec system receiver of claim 1, wherein the step S1 further comprises:
the phase-locked loop (PLL) comprises a phase detector, a high-performance loop filter, a phase accumulator and a low-pass filter, and the phase-locked loop (PLL) is configured for frequency shift keying (FSK) locking and tracking under a low signal-to-noise ratio and for frequency discrimination output.

3. The codeword synchronization method for a Sunspec system receiver of claim 1, wherein the step S2 further comprises:
selecting a suitable receiver sampling rate fs and an integration duration
$$Δ T = \frac{N}{{f}_{s}}$$
according to the modulation bit transmission time and FSK carrier modulation frequencies Fm and Fs specified by the Sunspec system, where N is a number of integration points, and
$$\{ \begin{matrix}{f}_{s} > 4 \cdot {F}_{S} \\ Ratio = \frac{{T}_{S} \cdot {f}_{s}}{N}\end{matrix}$$
wherein Ratio is a positive integer greater than or equal to 2;
wherein the receiver sampling rate is fs, the integration duration is
$$Δ T = \frac{N}{{f}_{s}} ,$$
N is the number of integration points, Ts=5.12 ms, Fm=131.25 kHz, Fs=143.75 kHz;
performing integrated data decision on an output PLL_out of the frequency discrimination information of the received signal, wherein an integration calculation is shown as follows:
$${Inte\_R}_{m} = {\sum }^{N - 1} Pll\_out ( n )$$
a rule expression of the integrated data decision result is shown as follows:
$$DD ( m ) = \{ \begin{matrix}1 , & {Inte\_R}_{m} > PThr \\ - 1 , & {Inte\_R}_{m} < - PThr \\ 0 , & others\end{matrix}$$
wherein PThr is an energy threshold greater than 1, n denotes an n-th sampling instant, m denotes an m-th integration period, and Inte_Rm is an accumulated value of N pieces of signal frequency discrimination data.

4. The codeword synchronization method for a Sunspec system receiver of claim 1, wherein the step S3 comprises:
calculating a time-domain expansion count according to the modulation bit transmission time and the integrated data decision duration of the Sunspec system, an expression of the time-domain expansion count being:
$$NC = \frac{{T}_{S}}{Δ T} = \frac{{T}_{S} \cdot {f}_{s}}{N}$$
wherein Ts denotes the modulation bit transmission time, ΔT denotes the integration duration, fs denotes the sampling rate, and NC denotes the time-domain expansion count;
obtaining the local template according to codeword W0[11]={+1, +1, +1, −1, −1, −1, +1, −1, −1, +1, −1} of the Sunspec system, an expression of the local template being:
$$W\_moban [ NC * 11 ] = \text{} \{ {\overbrace{W {0}_{0} , W {0}_{0} , … , W {0}_{0} , W {0}_{0}}}^{NC} , \\ {\overbrace{W {0}_{1} , W {0}_{1} , … , W {0}_{1} , W {0}_{1}}}^{NC} , \\ …… , {\overbrace{W {0}_{9} , W {0}_{9} , … , W {0}_{9} , W {0}_{9}}}^{NC} , {\overbrace{W {0}_{10} , W {0}_{10} , … , W {0}_{10} , W {0}_{10}}}^{NC} \}$$
wherein NC×11 represents a correlation data length.

5. The codeword synchronization method for a Sunspec system receiver of claim 1, wherein in the step S4, an expression of the first cross-correlation function is:
$${C}_{1} ( d ) = {\sum }^{NC * 11 - 1} DD ( d + m ) \cdot W\_moban ( m )$$
wherein NC×11 represents the correlation data length, and DD(d+m) denotes an integrated data decision result of a (d+m)-th period.

6. The codeword synchronization method for a Sunspec system receiver of claim 1, wherein in the step S5, an expression of the codeword transmission interval is:
$$CW\_D = \frac{{T}_{S}}{Δ T} * 11 = \frac{{T}_{S} \cdot {f}_{s}}{N} * 11 = \frac{11 \cdot {T}_{S} \cdot {f}_{s}}{N}$$
wherein CW_D denotes the codeword transmission interval, Ts denotes the modulation bit transmission time, ΔT denotes the integration duration, fs denotes the sampling rate, and N denotes the number of integration points.

7. The codeword synchronization method for a Sunspec system receiver of claim 1, wherein in the step S6, an expression of the second cross-correlation function value is:
$${C}_{2} ( d ) = {\sum }_{k = 0}^{2} \vert [ {C}_{1} ( d + k \cdot CW\_D ) ] \vert$$
wherein C₂(d) denotes the second cross-correlation function value.

8. The codeword synchronization method for a Sunspec system receiver of claim 1, wherein the step S7 comprises the steps of:
setting a codeword synchronization threshold and a correlation peak window;
and searching for a maximum peak value within the correlation peak window according to a magnitude of the second cross-correlation function value relative to the codeword synchronization threshold, and judging the codeword synchronization position.
